(19) United States
(12) Patent Application Publication
(10) Pub. No.: US 2026/0176934 A1
(43) Pub. Date: Jun. 25, 2026

(54) SELF ACTIVATING SEAL ASSEMBLY BACKUP

(71) Applicant: Halliburton Energy Services, Inc., Houston, TX (US)

(72) Inventor: Shanu Thottungal Eldho, Houston, TX (US)

(21) Appl. No.: 19/542,052

(22) Filed: Feb. 17, 2026

Related U.S. Application Data
(63) Continuation of application No. 17/334,724, filed on May 29, 2021, now abandoned.

(51) Int. Cl. E21B 33/10; F16J 15/00; F16J 15/16

(52) U.S. Cl. CPC E21B 33/10; F16J 15/002; F16J 15/164

(57) ABSTRACT

Provided is a seal assembly. The seal assembly, in one aspect, includes a first member, the first member formed of a first material, and a second member overlapping with the first member, the second member formed of a second material, the first and second members defining an overlapping fluid leakage path. The seal assembly according to this aspect further includes a primary seal positioned in the overlapping fluid leakage path, the primary seal configured to prevent fluid from passing from a first side of the overlapping fluid leakage path to a second side of the overlapping fluid leakage path. The seal assembly according to this aspect additionally includes an expandable metal backup seal positioned in the second side of the overlapping fluid leakage path, the expandable metal backup seal including a metal configured to expand in response to hydrolysis.

### CROSS-REFERENCE TO RELATED APPLICATION

This application is a continuation of U.S. patent application Ser. No. 17/334,724, entitled “SELF ACTIVATING SEAL ASSEMBLY BACKUP”, filed on May 29, 2021. The above-listed application is commonly assigned with the present application is incorporated herein by reference as if reproduced herein in its entirety.

### BACKGROUND

A seal is a device used to close a gap or make a joint fluid-tight with respect to fluid. Seals may be either static in nature or dynamic in nature. Static seals involve sealing surfaces that do not move relative to one another. In contrast, dynamic seals involve surfaces that do move relative to one another. Regardless of the type of seal, the seal is intended to provide a long-term complete physical barrier in a potential leakage path to which it is applied. To achieve this, the seal must be resilient to flow and fill any irregularities in the surface being sealed while resisting extrusion into the clearance gap between the surfaces under full system pressure. Unfortunately, seals are not fail safe, and thus have been known to fail.

### BRIEF DESCRIPTION

Reference is now made to the following descriptions taken in conjunction with the accompanying drawings, in which:

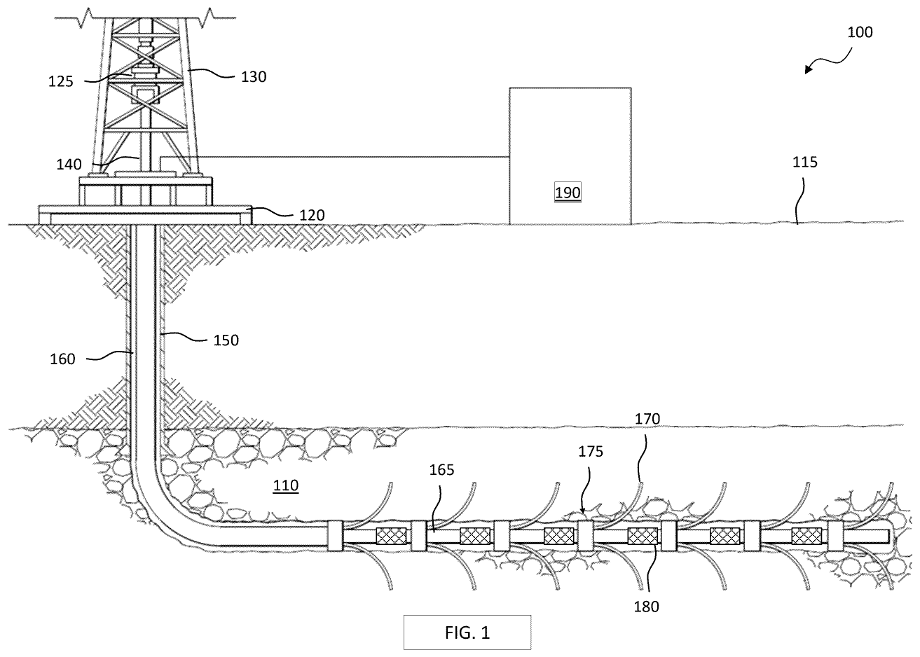

FIG. 1 illustrates a well system for hydrocarbon reservoir production, according to certain example embodiments;

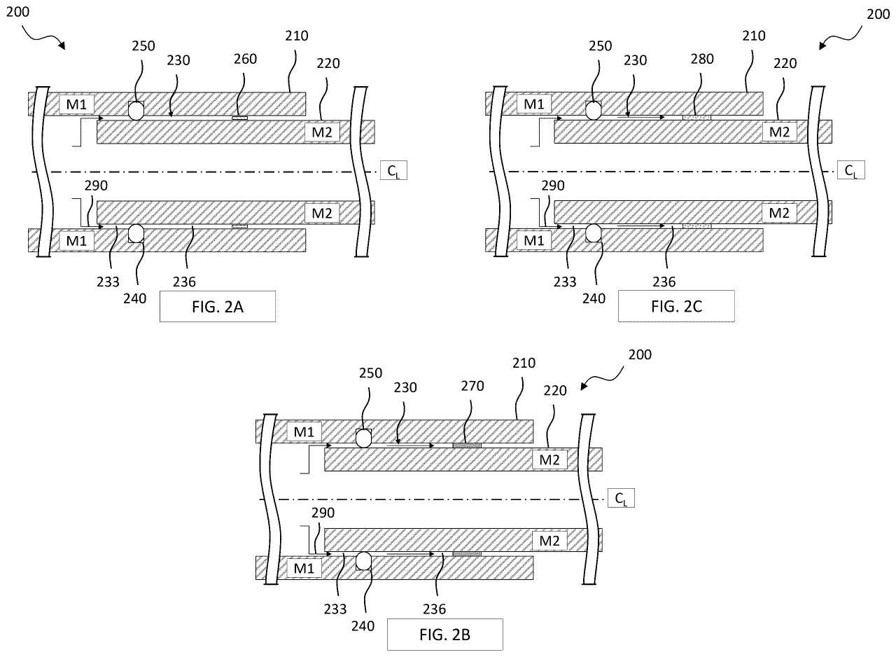

FIGS. 2A through 2C illustrate various different manufacturing states for a seal assembly designed, manufactured and operated according to one embodiment of the disclosure;

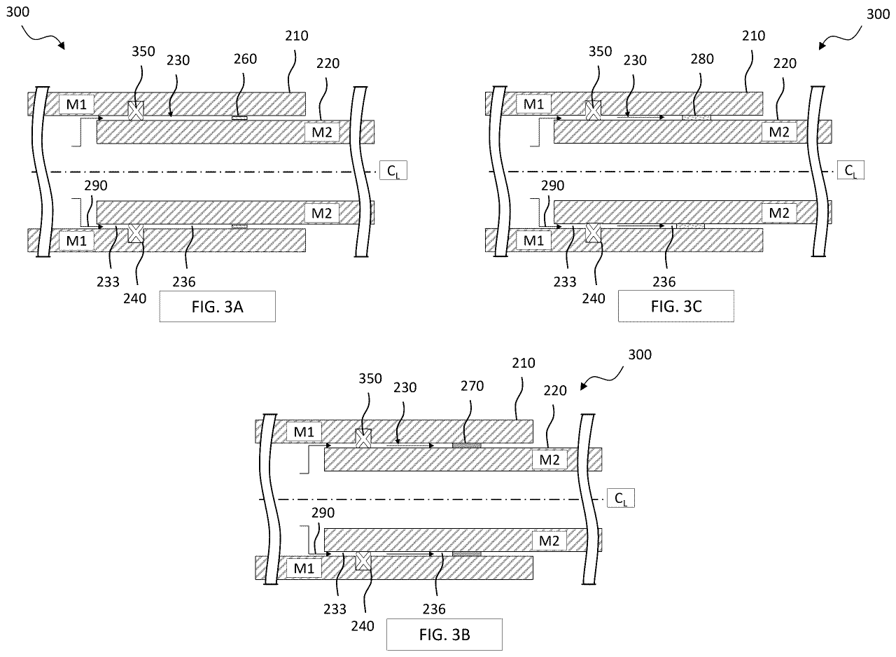

FIGS. 3A through 3C illustrate various different manufacturing states for a seal assembly designed, manufactured and operated according to an alternative embodiment of the disclosure;

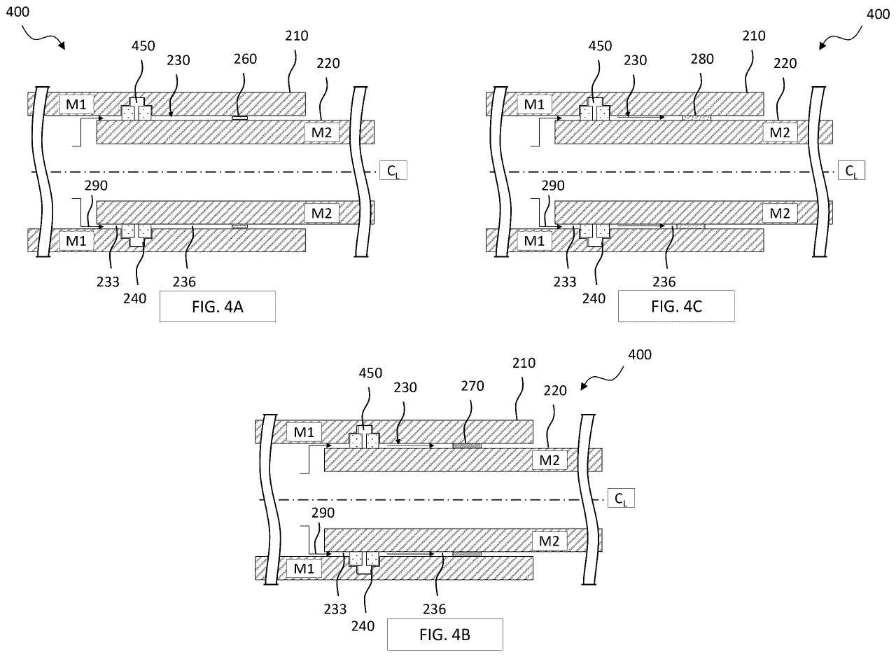

FIGS. 4A through 4C illustrate various different manufacturing states for a seal assembly designed, manufactured and operated according to an alternative embodiment of the disclosure;

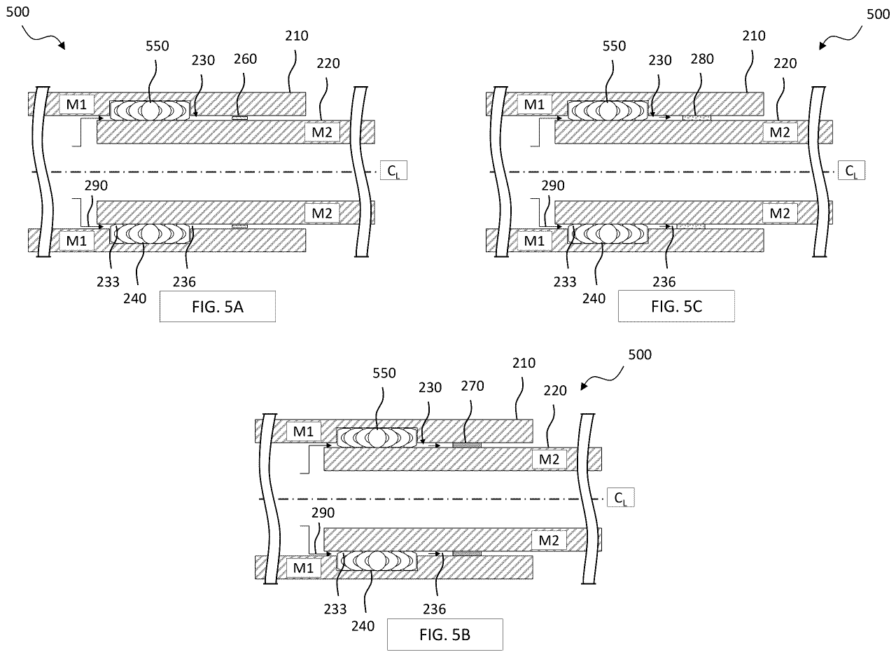

FIGS. 5A through 5C illustrate various different manufacturing states for a seal assembly designed, manufactured and operated according to an alternative embodiment of the disclosure;

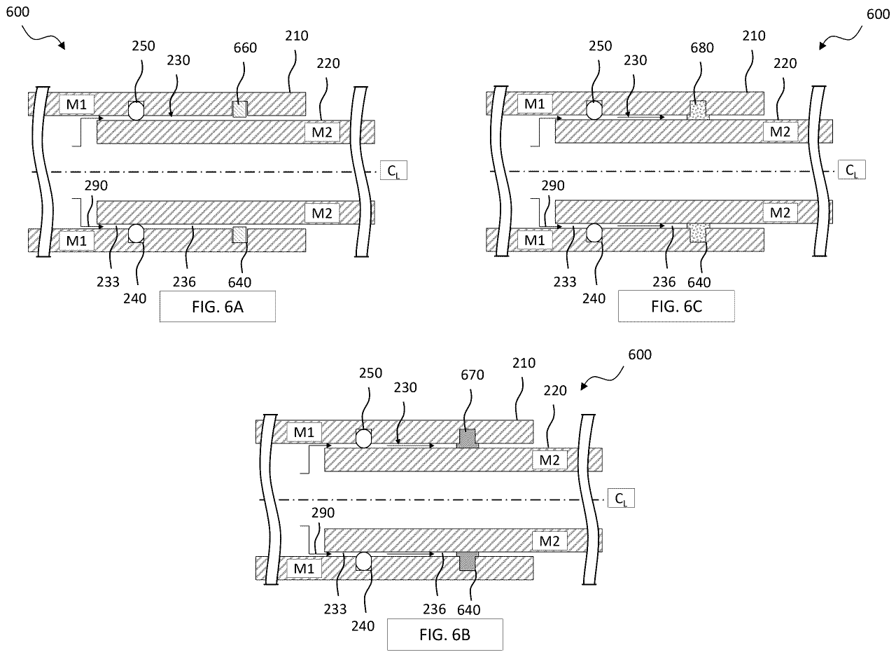

FIGS. 6A through 6C illustrate various different manufacturing states for a seal assembly designed, manufactured and operated according to an alternative embodiment of the disclosure;

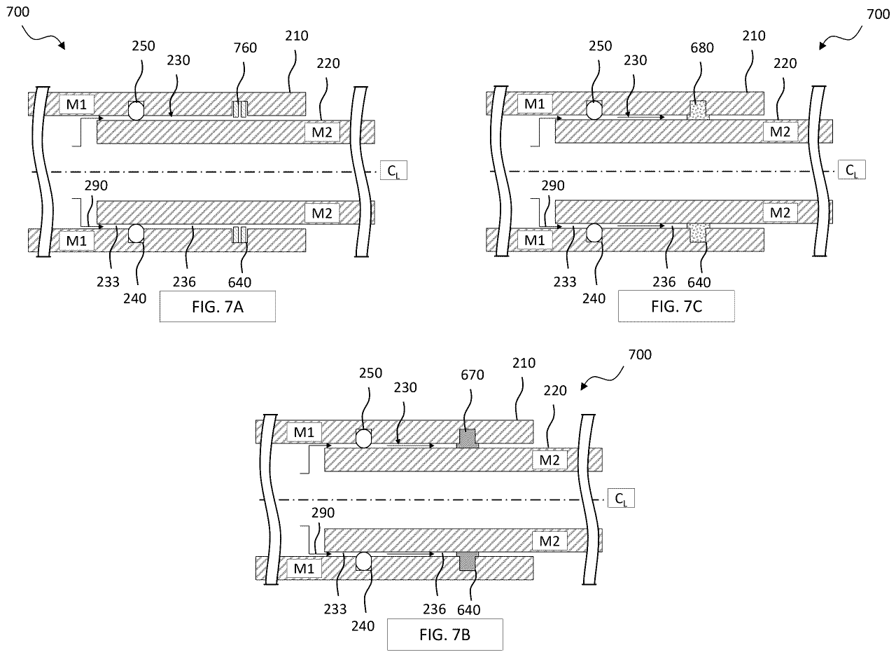

FIGS. 7A through 7C illustrate various different manufacturing states for a seal assembly designed, manufactured and operated according to an alternative embodiment of the disclosure;

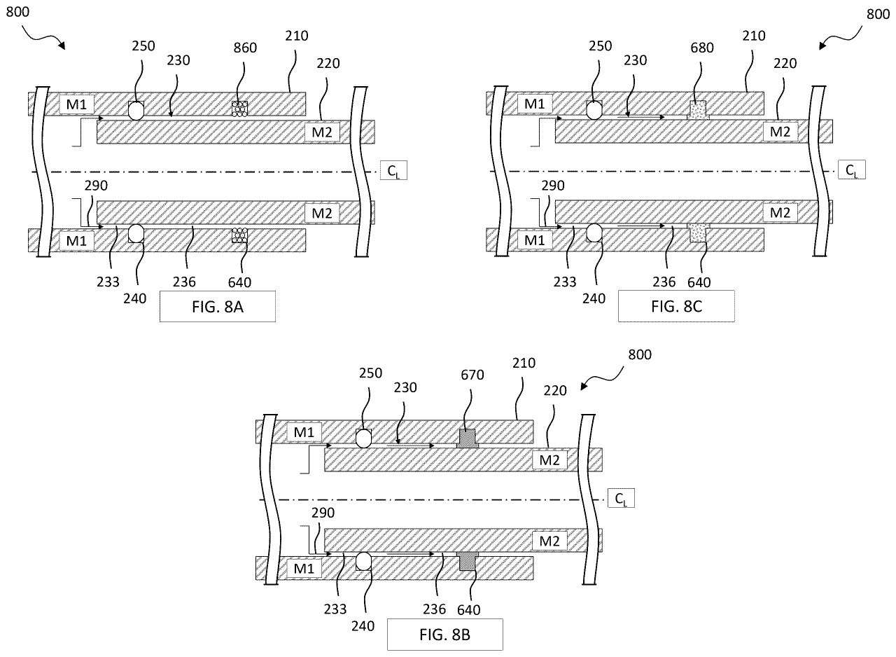

FIGS. 8A through 8C illustrate various different manufacturing states for a seal assembly designed, manufactured and operated according to an alternative embodiment of the disclosure;

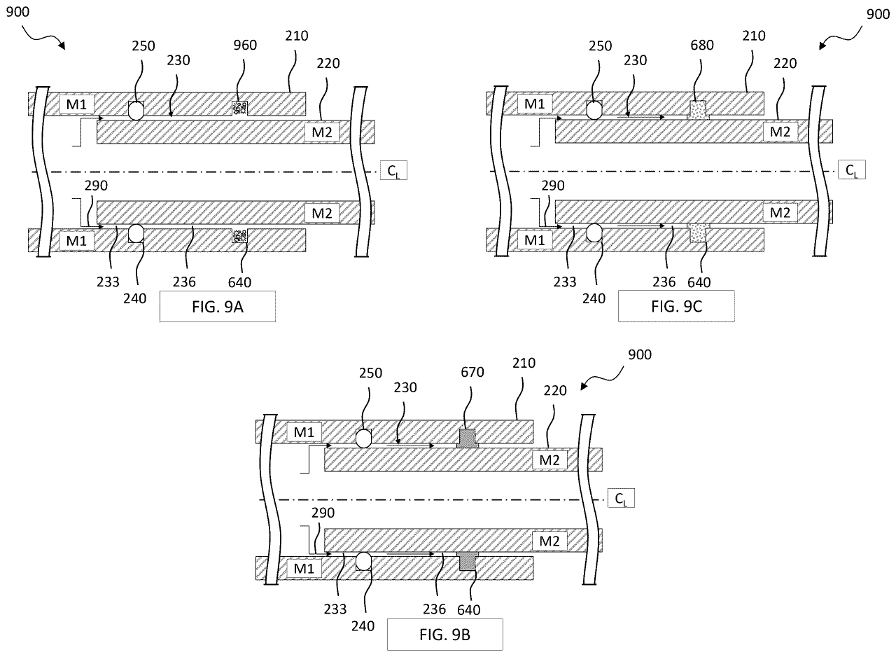

FIGS. 9A through 9C illustrate various different manufacturing states for a seal assembly designed, manufactured and operated according to an alternative embodiment of the disclosure;

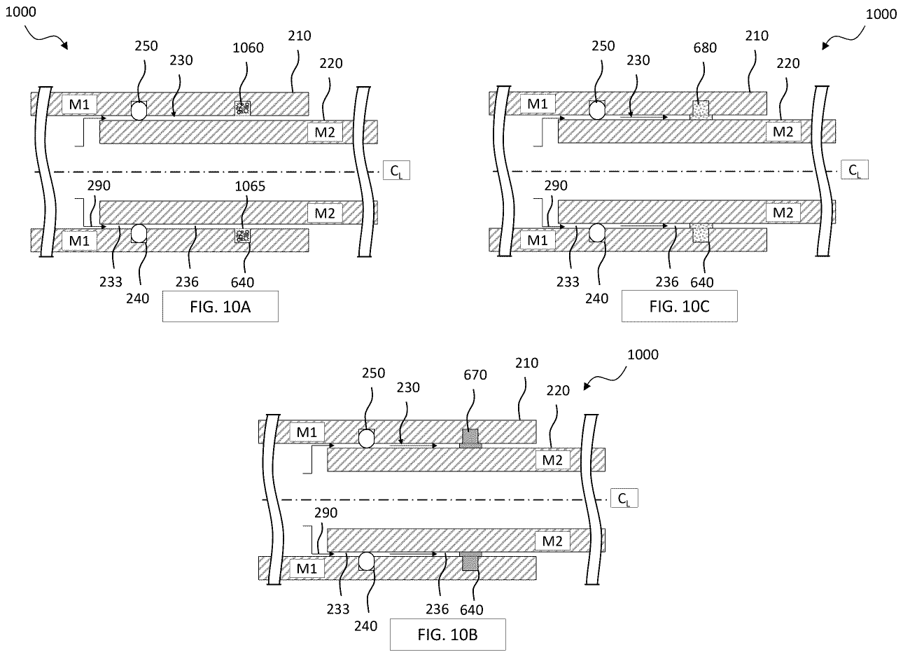

FIGS. 10A through 10C illustrate various different manufacturing states for a seal assembly designed, manufactured and operated according to an alternative embodiment of the disclosure;

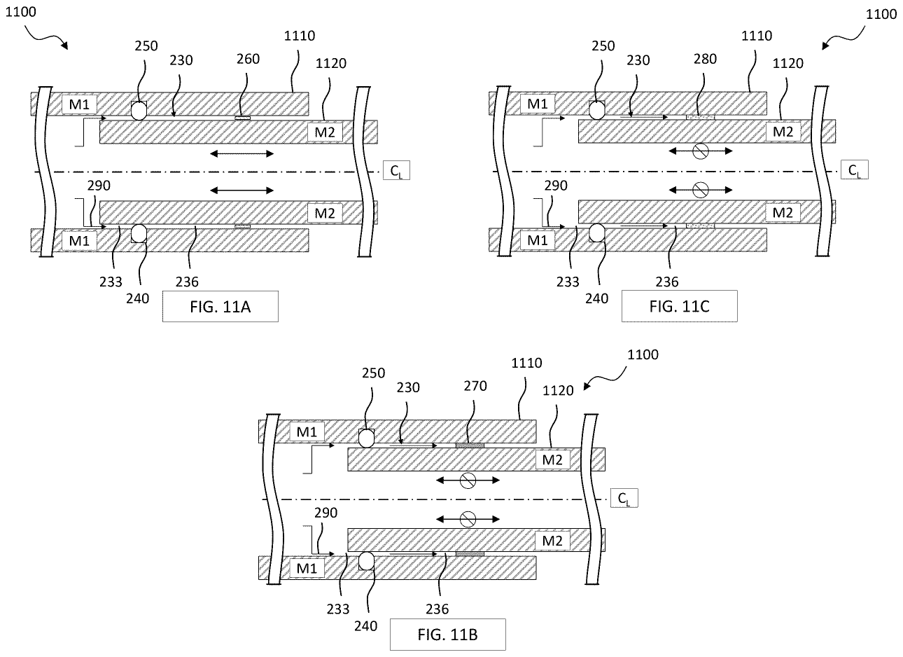

FIGS. 11A through 11C illustrate various different manufacturing states for a seal assembly designed, manufactured and operated according to an alternative embodiment of the disclosure; and

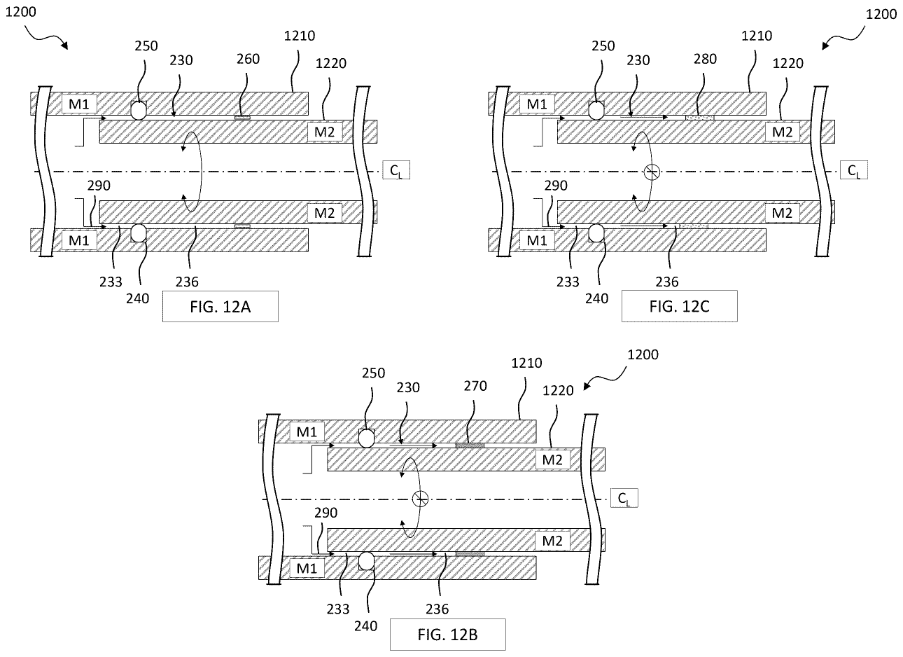

FIGS. 12A through 12C illustrate various different manufacturing states for a seal assembly designed, manufactured and operated according to an alternative embodiment of the disclosure.

### DETAILED DESCRIPTION

In the drawings and descriptions that follow, like parts are typically marked throughout the specification and drawings with the same reference numerals, respectively. The drawn figures are not necessarily to scale. Certain features of the disclosure may be shown exaggerated in scale or in somewhat schematic form and some details of certain elements may not be shown in the interest of clarity and conciseness. The present disclosure may be implemented in embodiments of different forms.

Specific embodiments are described in detail and are shown in the drawings, with the understanding that the present disclosure is to be considered an exemplification of the principles of the disclosure, and is not intended to limit the disclosure to that illustrated and described herein. It is to be fully recognized that the different teachings of the embodiments discussed herein may be employed separately or in any suitable combination to produce desired results.

Unless otherwise specified, use of the terms “connect,” “engage,” “couple,” “attach,” or any other like term describing an interaction between elements is not meant to limit the interaction to a direct interaction between the elements and may also include an indirect interaction between the elements described. Unless otherwise specified, use of the terms “up,” “upper,” “upward,” “uphole,” “upstream,” or other like terms shall be construed as generally away from the bottom, terminal end of a well; likewise, use of the terms “down,” “lower,” “downward,” “downhole,” or other like terms shall be construed as generally toward the bottom, terminal end of the well, regardless of the wellbore orientation. Use of any one or more of the foregoing terms shall not be construed as denoting positions along a perfectly vertical axis. In some instances, a part near the end of the well can be horizontal or even slightly directed upwards. Unless otherwise specified, use of the term “subterranean formation” shall be construed as encompassing both areas below exposed earth and areas below earth covered by water such as ocean or fresh water.

The present disclosure describes a seal assembly including an expandable metal backup seal positioned in an overlapping fluid leakage path thereof. As will be understood more fully below, the expandable metal backup seal begins as a metal, and after being subjected to an activation fluid (whether intentional or not), changes to a hard, fluid impermeable material. In certain embodiments, the hard, fluid impermeable material contains a certain amount of unreacted expandable metal, and thus may be self-healing and/or self-repairing.

The expandable metal backup seal has many different applications when sealing two surfaces, as well as provides certain advantages (e.g., incremental and radical advantages) over existing seal assemblies. For example, the expandable metal backup seal may act as a backup seal to a primary seal in certain application. In such applications, if the primary seal were to fail, whether a lot or a little, the fluid would then self-activate the expandable metal backup seal, and thus provide an expanded metal backup seal. Such an application is highly valuable when the seal assembly is a static seal assembly or dynamic seal assembly. In other embodiments, the expandable metal backup seal might not only act as a backup seal to the primary seal, but could also act as a leak indicator. For example, if the seal assembly were a dynamic seal assembly, the expanded metal backup seal would stop the features of the dynamic seal assembly from moving relative to one another, and in doing so indicate to the user that a leak was present. While the expanded metal backup seal would render the tool that it was included within unfit for its intended purpose (e.g., as the features of the dynamic seal assembly would no longer be allowed to move relative to one another), it could prevent other more costly issues.

The expandable metal may additionally be modified to include various fillers, which could change one or more properties of the resulting expanded metal backup seal. For example, the expandable metal could be modified to result in enhanced and/or performance calibrated material properties, such as: improved mechanical properties-shear strength, impact toughness, tensile strength, modulus of elasticity, elongation, thermal expansion etc.; improved electrical properties-conductivity, resistivity etc.; improved optical properties-refractive index, light transmissibility etc.; improved chemical properties-activation time, reaction rate etc.; as well as improved physical properties, magnetic properties and acoustical properties, to name a few.

Referring now to FIG. 1, illustrated is a well system 100 for hydrocarbon reservoir production, according to certain example embodiments of the disclosure. The well system 100 illustrated in FIG. 1 includes a platform 120 positioned over a subterranean formation 110 located below the earth's surface 115. The platform 120, in at least one embodiment, has a hoisting apparatus 125 and a derrick 130 for raising and lowering a downhole conveyance 140, such as a drill string, a completion string, a stimulation string, a workover string, production string, as well as any variations of the above.

The well system 100, in one or more embodiments, includes a main wellbore 150. The main wellbore 150, in the illustrated embodiment, includes tubing 160, 165, which may have differing tubular diameters. Extending from the main wellbore 150, in one or more embodiments, may be one or more lateral wellbores 170. Furthermore, a plurality of multilateral junctions 175 may be positioned at a junction between the main wellbore 150 and the lateral wellbores 170. Each multilateral junction 175 may comprise a y-block in one or more embodiments. The well system 100 may additionally include one or more interval control valves (ICVs) 180 positioned at various positions within the main wellbore 150 and/or one or more of the lateral wellbores 170. The well system 100 may additionally include an uphole unit 190. The uphole unit 190, in one embodiment, is a control unit operable to provide control to or receive signals from, one or more downhole devices. The uphole unit 190, in another embodiment, is a pumping station.

The well system 100 may further include a seal assembly (not shown) designed, manufactured and operated according to one or more embodiments of the disclosure. The seal assembly, in accordance with one embodiment of the disclosure, includes a first member, the first member formed of a first material, a second member overlapping with the first member, the second member formed of a second material, the first and second members defining an overlapping fluid leakage path. The seal assembly according to this embodiment further includes a primary seal positioned in the overlapping fluid leakage path, the primary seal configured to prevent fluid from passing from a first side of the overlapping fluid leakage path to a second side of the overlapping fluid leakage path. The seal assembly according to this embodiment further includes an expandable metal backup seal positioned in the second side of the overlapping fluid leakage path, the expandable metal backup seal including a metal configured to expand in response to hydrolysis.

The seal assembly could be located at just about any location within the well system 100, whether above the earth's surface 115 or below the earth's surface 115. For example, the seal assembly could form at least a portion of the completion string (e.g., production string) of the well system 100, and thus could form at least a portion of the tubing 160, 165, multilateral junctions 175, ICVs 180, etc. Similarly, the seal assembly could form at least a portion of the drill string, stimulation string, or workover string used to form and/or access the wellbores 150, 170. Additionally, the seal assembly might form at least a portion of the uphole unit 190. Furthermore, even though the seal assembly is being discussed with regard to an oil and gas application, and more specifically to a well system, a seal assembly according to the disclosure is not limited to use in just oil and gas applications. Accordingly, unless otherwise stated, a seal assembly according to the present disclosure should not be limited to any specific application, and thus would suffice in any situation wherein a primary seal has been used, and a backup seal might be desired.

The expandable metal backup seal, in at least one embodiment, is configured to expand to generally fill the overlapping fluid leakage path between the two or more features that are being sealed, for example if or when the primary seal leaks. The overlapping fluid leakage path, in at least one embodiment, includes the space created between opposing surfaces of the two or more features, regardless of the relative orientation (e.g. parallel with the longitudinal axis of the two or more features, perpendicular with the longitudinal axis of the two or more features, or angled relative to the longitudinal axis of the two or more features).

The expandable metal backup seal in the overlapping fluid leakage path, in one or more embodiments, has a cross-sectional area of no more than 30 cm². In yet another embodiment, the expandable metal backup seal in the overlapping fluid leakage path has a cross-sectional area ranging from 3 cm² to 20 cm². Once the expandable metal backup seal has been subjected to an activation fluid, and thus becomes an expanded metal backup seal, the expanded metal backup seal has a cross-sectional area of no more than 60 cm² in at least one embodiment. In yet another embodiment, the expanded metal backup seal in the overlapping fluid leakage path has a cross-sectional area ranging from 7 cm² to 52 cm². Nevertheless, the volume of the expandable metal backup seal should be designed to provide an adequate backup seal for the two or more features being joined, but otherwise is not limited to any specific values.

Again, in certain embodiments, the expanded metal backup seal includes residual unreacted expandable metal therein. For example, in certain embodiments the expanded metal backup seal is intentionally designed to include the residual unreacted expandable metal therein. The residual unreacted expandable metal has the benefit of allowing the expanded metal backup seal to self-heal if cracks or other anomalies subsequently arise. Nevertheless, other embodiments may exist wherein no residual unreacted expandable metal exists in the expanded metal backup seal.

The expandable metal, in some embodiments, may be described as expanding to a cement like material. In other words, the metal goes from metal to micron-scale particles and then these particles expand and lock together to, in essence, lock the expanded metal backup seal in place. The reaction may, in certain embodiments, occur in less than 24 hours in a reactive fluid and acceptable temperatures. Nevertheless, the time of reaction may vary depending on the reactive fluid, the expandable metal used, thickness of the expandable metal used, and the temperature.

In some embodiments, the reactive fluid may be a brine solution such as may be produced during well completion activities, and in other embodiments, the reactive fluid may be one of the additional solutions discussed herein. The metal, pre-expansion, is electrically conductive in certain embodiments. The metal may be machined to any specific size/shape, extruded, forged, cast, printed or other conventional ways to get the desired shape of a metal, as will be discussed in greater detail below. Metal, pre-expansion, in certain embodiments has a yield strength greater than about 8,000 psi, e.g., 8,000 psi+/−50%.

The hydrolysis of the metal can create a metal hydroxide. The formative properties of alkaline earth metals (Mg—Magnesium, Ca—Calcium, etc.) and transition metals (Zn—Zinc, Al—Aluminum, etc.) under hydrolysis reactions demonstrate structural characteristics that are favorable for use with the present disclosure. Hydration results in an increase in size from the hydration reaction and results in a metal hydroxide that can precipitate from the fluid.

The hydration reactions for magnesium is:

Mg+2H₂O→Mg(OH)₂+H₂,

where Mg(OH)₂ is also known as brucite. Another hydration reaction uses aluminum hydrolysis. The reaction forms a material known as Gibbsite, bayerite, and norstrandite, depending on form. The hydration reaction for aluminum is:

Al+3H₂O→Al(OH)₃+3/2 H₂.

Another hydration reactions uses calcium hydrolysis. The hydration reaction for calcium is:

Ca+2H₂O→Ca(OH)₂+H₂,

Where Ca(OH)₂ is known as portlandite and is a common hydrolysis product of Portland cement. Magnesium hydroxide and calcium hydroxide are considered to be relatively insoluble in water. Aluminum hydroxide can be considered an amphoteric hydroxide, which has solubility in strong acids or in strong bases. Each of the above, may commonly be referred to as an expanded metal cement like material.

In an embodiment, the metallic material used can be a metal alloy. The metal alloy can be an alloy of the base metal with other elements in order to either adjust the strength of the metal alloy, to adjust the reaction time of the metal alloy, or to adjust the strength of the resulting metal hydroxide byproduct, among other adjustments. The metal alloy can be alloyed with elements that enhance the strength of the metal such as, but not limited to, Al—Aluminum, Zn—Zinc, Mn—Manganese, Zr—Zirconium, Y—Yttrium, Nd—Neodymium, Gd—Gadolinium, Ag—Silver, Ca—Calcium, Sn—Tin, and Re—Rhenium, Cu—Copper. In some embodiments, the alloy can be alloyed with a dopant that promotes corrosion, such as Ni—Nickel, Fe—Iron, Cu—Copper, Co—Cobalt, Ir—Iridium, Au—Gold, C—Carbon, Ga—Gallium, In—Indium, Mg—Mercury, Bi—Bismuth, Sn—Tin, and Pd—Palladium. The metal alloy can be constructed in a solid solution process where the elements are combined with molten metal or metal alloy. Alternatively, the metal alloy could be constructed with a powder metallurgy process. The metal can be cast, forged, extruded, sintered, welded, mill machined, lathe machined, stamped, eroded or a combination thereof.

Optionally, non-expanding components may be added to the starting metallic materials. For example, ceramic, elastomer, plastic, epoxy, glass, or non-reacting metal components can be embedded in the expanding metal or coated on the surface of the metal. Alternatively, the starting metal may be the metal oxide. For example, calcium oxide (CaO) with water will produce calcium hydroxide in an energetic reaction. Due to the higher density of calcium oxide, this can have a 260% volumetric expansion where converting 1 mole of CaO goes from 9.5 cc to 34.4 cc of volume. In one variation, the expanding metal is formed in a serpentinite reaction, a hydration and metamorphic reaction. In one variation, the resultant material resembles a mafic material. Additional ions can be added to the reaction, including silicate, sulfate, aluminate, carbonate, and phosphate. The metal can be alloyed to increase the reactivity or to control the formation of oxides.

The expandable metal backup seal can be configured in many different fashions, as long as an adequate volume of material is available for fully expanding. For example, the expandable metal backup seal may be formed into a single long member, multiple short members, one or more rings, wraps of expandable metal wire, alternating steel and swellable rubber and expandable metal rings, among others. In certain other embodiments, the expandable metal backup seal is a collection of individual separate chunks of the expandable metal held together with a binding agent. In yet other embodiments, the expandable metal backup seal is a collection of individual separate chunks of the expandable metal that are not held together with a binding agent, but held in place with a screen member, as will be discussed in greater detail below. Additionally, a coating may be applied to one or more portions of the expandable metal backup seal to delay the expanding reactions.

Turning to FIGS. 2A through 2C, depicted are various different manufacturing states for a seal assembly 200 designed, manufactured and operated according to the disclosure. FIG. 2A illustrates the seal assembly 200 pre-expansion, FIG. 2B illustrates the seal assembly 200 post-expansion, and FIG. 2C illustrates the seal assembly 200 post-expansion and containing residual unreacted expandable metal therein. The seal assembly 200 of FIGS. 2A through 2C includes a first member 210 and second member 220. In the embodiment illustrated in FIGS. 2A through 2C, the first member 210 and the second member 220 are fixed relative to one another, thereby forming a static seal. In accordance with one or more embodiments of the disclosure, the first member 210 comprises a first material (M1) and the second member 220 comprises a second material (M2). In certain embodiments, the first material (M1) and the second material (M2) are the same material, but in other embodiments the first material (M1) and the second material (M2) are different materials.

In the illustrated embodiment, and in accordance with the disclosure, the first member 210 and the second member 220 overlap one another, thereby forming an overlapping fluid leakage path 230. Depending on the design, the overlap may be face-to-face, end-to-end, but-to-but, or any other overlap, as well as combinations of the same. The first member 210 and the second member 220, in the illustrated embodiment, thus define the overlapping fluid leakage path 230.

While not required, the first member 210 and the second member 220 are a first tubular and a second tubular in the embodiment discussed with regard to FIGS. 2A through 2C. Accordingly, the first member 210 and the second member 220 define a centerline (CL) in the embodiments shown. For example, in the embodiment of FIGS. 2A through 2C, the second tubular member is positioned within the first tubular member. In other embodiments, however, one or both of the first member 210 or the second member 220 are not tubulars.

The seal assembly 200, in one or more embodiments, additionally includes a primary seal 250 positioned in the overlapping fluid leakage path 230. In one or more embodiments, the primary seal 250 is configured to prevent fluid 290 from passing from a first side 233 of the overlapping fluid leakage path 230 to a second side 236 of the overlapping fluid leakage path 230. The primary seal 250 may have many different locations and remain within the scope of the present disclosure. In the illustrated embodiment of FIGS. 2A through 2C, the primary seal 250 is located within a first groove 240. The first groove 240 may be located in either one of the first member 210 or the second member 220. Nevertheless, in the embodiment of FIGS. 2A through 2C, the first groove 240 is located within the first member 210.

The primary seal 250 may also comprise many different seals and remain within the scope of the disclosure. For example, in the embodiment of FIGS. 2A through 2C, the primary seal 250 is a ring shaped seal located within the first groove 240. In at least one embodiment, such as that shown in FIGS. 2A through 2C, the primary seal 250 is an O-ring seal. In yet other embodiments, however, the primary seal 250 might be an X-ring seal, or a T-ring seal, among others. In yet other embodiments, the primary seal 250 might be a chevron seal. Furthermore, the primary seal may comprise a plastic seal, polymeric seal, elastomeric seal, metal seal, or any other known seal material.

With reference to FIG. 2A, in or more embodiments of the disclosure, an expandable metal backup seal 260 is positioned in the second side 236 of the overlapping fluid leakage path 230. The expandable metal backup seal 260, in accordance with one or more embodiments of the disclosure, comprises a metal configured to expand in response to hydrolysis. The expandable metal backup seal 260, in the illustrated embodiment, may comprise any of the expandable metals discussed above, or any combination of the same.

The expandable metal backup seal 260 may have a variety of different lengths and thicknesses, for example depending on the amount of sealing effect needed, and remain within the scope of the disclosure. The expandable metal backup seal 260 may also comprise many different shapes and remain within the scope of the disclosure. In the embodiment of FIG. 2A, the expandable metal backup seal 260 is a single solid ring of expandable material. In the embodiment of FIG. 2A, the expandable metal backup seal 260 is in an unexpanded state that does not provide a fluid tight seal to the overlapping fluid leakage path 230. The term fluid tight, as used herein, is intended to encompass a seal that can withstand at least 140,000 kPa of pressure.

With reference to FIG. 2B, illustrated is the expandable metal backup seal 260 illustrated in FIG. 2A after having been subjecting to fluid 290 to expand the metal in the overlapping fluid leakage path 230, and thereby form an expanded metal backup seal 270. In the illustrated embodiment, the expanded metal backup seal 270 generally fills the overlapping space, and thus forms a backup seal to the primary seal 250. In the embodiment of FIG. 2B, the expanded metal backup seal 270 is in an expanded state that does provide a fluid tight seal to the overlapping fluid leakage path 230.

With reference to FIG. 2C, illustrated is the expandable metal backup seal 260 illustrated in FIG. 2A after having been subjecting to fluid 290 to expand the metal in the overlapping fluid leakage path 230, and thereby form an expanded metal backup seal 280 including residual unreacted expandable metal therein. In one embodiment, the expanded metal backup seal 280 includes at least 1% residual unreacted expandable metal therein. In yet another embodiment, the expanded metal backup seal 280 includes at least 3% residual unreacted expandable metal therein. In even yet another embodiment, the expanded metal backup seal 280 includes at least 10% residual unreacted expandable metal therein, and in certain embodiments at least 20% residual unreacted expandable metal therein. In the embodiment of FIG. 2C, the expanded metal backup seal 280 including residual unreacted expandable metal therein is in an expanded state that does provide a fluid tight seal to the overlapping fluid leakage path 230. For example, the expanded metal backup seal 280 including residual unreacted expandable metal might include an expanded metal cement like material and residual unreacted metal configured to expand in response to the hydrolysis

Turning now to FIGS. 3A through 3C, depicted are various different manufacturing states for a seal assembly 300 designed, manufactured and operated according to an alternative embodiment of the disclosure. FIG. 3A illustrates the seal assembly 300 pre-expansion, FIG. 3B illustrates the seal assembly 300 post-expansion, and FIG. 3C illustrates the seal assembly 300 post-expansion and containing residual unreacted expandable metal therein. The seal assembly 300 of FIGS. 3A through 3C is similar in many respects to the seal assembly 200 of FIGS. 2A through 2C. Accordingly, like reference numbers have been used to illustrate similar, if not identical, features. The seal assembly 300 differs, for the most part, from the seal assembly 200, in that the seal assembly 300 employs an X-ring seal as its primary seal 350.

Turning now to FIGS. 4A through 4C, depicted are various different manufacturing states for a seal assembly 400 designed, manufactured and operated according to an alternative embodiment of the disclosure. FIG. 4A illustrates the seal assembly 400 pre-expansion, FIG. 4B illustrates the seal assembly 400 post-expansion, and FIG. 4C illustrates the seal assembly 400 post-expansion and containing residual unreacted expandable metal therein. The seal assembly 400 of FIGS. 4A through 4C is similar in many respects to the seal assembly 200 of FIGS. 2A through 2C. Accordingly, like reference numbers have been used to illustrate similar, if not identical, features. The seal assembly 400 differs, for the most part, from the seal assembly 200, in that the seal assembly 400 employs a T-ring seal as its primary seal 450.

Turning now to FIGS. 5A through 5C, depicted are various different manufacturing states for a seal assembly 500 designed, manufactured and operated according to an alternative embodiment of the disclosure. FIG. 5A illustrates the seal assembly 500 pre-expansion, FIG. 5B illustrates the seal assembly 500 post-expansion, and FIG. 5C illustrates the seal assembly 500 post-expansion and containing residual unreacted expandable metal therein. The seal assembly 500 of FIGS. 5A through 5C is similar in many respects to the seal assembly 200 of FIGS. 2A through 2C. Accordingly, like reference numbers have been used to illustrate similar, if not identical, features. The seal assembly 500 differs, for the most part, from the seal assembly 200, in that the seal assembly 500 employs a chevron seal as its primary seal 550.

Turning now to FIGS. 6A through 6C, depicted are various different manufacturing states for a seal assembly 600 designed, manufactured and operated according to an alternative embodiment of the disclosure. FIG. 6A illustrates the seal assembly 600 pre-expansion, FIG. 6B illustrates the seal assembly 600 post-expansion, and FIG. 6C illustrates the seal assembly 600 post-expansion and containing residual unreacted expandable metal therein. The seal assembly 600 of FIGS. 6A through 6C is similar in many respects to the seal assembly 200 of FIGS. 2A through 2C. Accordingly, like reference numbers have been used to illustrate similar, if not identical, features. The seal assembly 600 differs, for the most part, from the seal assembly 200, in that the seal assembly 600 has its expandable metal backup seal 660, its expanded metal backup seal 670, and its expanded metal backup seal 680 including residual unreacted expandable metal therein located in a second groove 640. The second groove 640 may be located in either one of the first member 210 or the second member 220. Nevertheless, in the embodiment of FIGS. 6A through 6C, the second groove 640 is located within the first member 210.

Turning now to FIGS. 7A through 7C, depicted are various different manufacturing states for a seal assembly 700 designed, manufactured and operated according to an alternative embodiment of the disclosure. FIG. 7A illustrates the seal assembly 700 pre-expansion, FIG. 7B illustrates the seal assembly 700 post-expansion, and FIG. 7C illustrates the seal assembly 700 post-expansion and containing residual unreacted expandable metal therein. The seal assembly 700 of FIGS. 7A through 7C is similar in many respects to the seal assembly 600 of FIGS. 6A through 6C. Accordingly, like reference numbers have been used to illustrate similar, if not identical, features. The seal assembly 700 differs, for the most part, from the seal assembly 600, in that the seal assembly 700 employs multiple solid rings of expandable metal for its expandable metal backup seal 760.

Turning now to FIGS. 8A through 8C, depicted are various different manufacturing states for a seal assembly 800 designed, manufactured and operated according to an alternative embodiment of the disclosure. FIG. 8A illustrates the seal assembly 800 pre-expansion, FIG. 8B illustrates the seal assembly 800 post-expansion, and FIG. 8C illustrates the seal assembly 800 post-expansion and containing residual unreacted expandable metal therein. The seal assembly 800 of FIGS. 8A through 8C is similar in many respects to the seal assembly 600 of FIGS. 6A through 6C. Accordingly, like reference numbers have been used to illustrate similar, if not identical, features. The seal assembly 800 differs, for the most part, from the seal assembly 600, in that the seal assembly 800 employs two or more wraps of expandable metal for its expandable metal backup seal 860.

Turning now to FIGS. 9A through 9C, depicted are various different manufacturing states for a seal assembly 900 designed, manufactured and operated according to an alternative embodiment of the disclosure. FIG. 9A illustrates the seal assembly 900 pre-expansion, FIG. 9B illustrates the seal assembly 900 post-expansion, and FIG. 9C illustrates the seal assembly 900 post-expansion and containing residual unreacted expandable metal therein. The seal assembly 900 of FIGS. 9A through 9C is similar in many respects to the seal assembly 600 of FIGS. 6A through 6C. Accordingly, like reference numbers have been used to illustrate similar, if not identical, features. The seal assembly 900 differs, for the most part, from the seal assembly 600, in that the seal assembly 900 employs a collection of individual separate chunks of the expandable metal held together with a binding agent for its expandable metal backup seal 960. In theory, the binding agent would dissolve over time thereby allowing the individual separate chunks of the metal to expand via the hydrolysis. The binding agent, in one embodiment is salt, but the present disclosure is not limited to any specific binding agent.

In certain embodiments, the collection of individual separate chunks of the metal are a collection of individual separate different sized chunks of the metal. For example, in certain embodiments a volume of the largest most individual chunk of the metal is at least 5 times the volume of the smallest most individual chunk of the metal. In yet other embodiments, a volume of the largest most individual chunk of the metal is at least 50 times a volume of the smallest most individual chunk of the metal. If the individual separate chunks of the metal were spheres, in certain embodiments a diameter of the largest most individual chunk of the metal might be at least 2 times a diameter of the smallest most individual chunk of the metal, and in yet another embodiment a diameter of the largest most individual chunk of the metal might be at least 10 times a diameter of the smallest most individual chunk of the metal. The variation in sizes of the individual separate chunks of the metal allow the individual chunks to reach places where they might not otherwise desirably reach, as well as prevent the individual separate chunks of the metal from reaching places they might otherwise undesirably reach.

Turning now to FIGS. 10A through 10C, depicted are various different manufacturing states for a seal assembly 1000 designed, manufactured and operated according to an alternative embodiment of the disclosure. FIG. 10A illustrates the seal assembly 1000 pre-expansion, FIG. 10B illustrates the seal assembly 1000 post-expansion, and FIG. 10C illustrates the seal assembly 1000 post-expansion and containing residual unreacted expandable metal therein. The seal assembly 1000 of FIGS. 10A through 10C is similar in many respects to the seal assembly 900 of FIGS. 9A through 9C. Accordingly, like reference numbers have been used to illustrate similar, if not identical, features. The seal assembly 1000 differs, for the most part, from the seal assembly 900, in that the seal assembly 1000 does not employ a binding agent for its expandable metal backup seal 1060, but employs a screen member 1065 to hold the individual separate chunks of the expandable metal in place.

Turning now to FIGS. 11A through 11C, depicted are various different manufacturing states for a seal assembly 1100 designed, manufactured and operated according to an alternative embodiment of the disclosure. FIG. 11A illustrates the seal assembly 1100 pre-expansion, FIG. 11B illustrates the seal assembly 1100 post-expansion, and FIG. 11C illustrates the seal assembly 1100 post-expansion and containing residual unreacted expandable metal therein. The seal assembly 1100 of FIGS. 11A through 11C is similar in many respects to the seal assembly 200 of FIGS. 2A through 2C. Accordingly, like reference numbers have been used to illustrate similar, if not identical, features. The seal assembly 1100 differs, for the most part, from the seal assembly 200, in that wherein the first and second members 210, 220 of FIG. 2A are fixed relative to one another, the first and second members 1110, 1120 of FIG. 11A move relative to one another. Accordingly, the first and second members 1110, 1120 form at least a portion of a dynamic seal. For example, in the embodiment of FIG. 11A the first and second members 1110, 1120 translate relative to one another. Accordingly, when the expandable metal backup seal 260 is exposed to the fluid 290, and thus becomes the expanded metal backup seal 270 or the expanded metal backup seal 280 including residual unreacted expandable metal therein, the first and second members 1110, 1120 become translationally fixed relative to one another, as shown in FIGS. 11B and 11C. Accordingly, a user of the seal assembly 1100 would know that the primary seal 250 has leaked as a result of the first and second members 1110, 1120 being translationally fixed relative to one another.

Turning now to FIGS. 12A through 12C, depicted are various different manufacturing states for a seal assembly 1200 designed, manufactured and operated according to an alternative embodiment of the disclosure. FIG. 12A illustrates the seal assembly 1200 pre-expansion, FIG. 12B illustrates the seal assembly 1200 post-expansion, and FIG. 12C illustrates the seal assembly 1200 post-expansion and containing residual unreacted expandable metal therein. The seal assembly 1200 of FIGS. 12A through 12C is similar in many respects to the seal assembly 200 of FIGS. 2A through 2C. Accordingly, like reference numbers have been used to illustrate similar, if not identical, features. The seal assembly 1200 differs, for the most part, from the seal assembly 200, in that wherein the first and second members 210, 220 of FIG. 2A are fixed relative to one another, the first and second members 1210, 1220 of FIG. 12A move relative to one another. Accordingly, the first and second members 1210, 1220 form at least a portion of a dynamic seal. For example, in the embodiment of FIG. 12A the first and second members 1210, 1220 rotate relative to one another. Accordingly, when the expandable metal backup seal 260 is exposed to the fluid 290, and thus becomes the expanded metal backup seal 270 or the expanded metal backup seal 280 including residual unreacted expandable metal therein, the first and second members 1210, 1220 become rotationally fixed relative to one another, as shown in FIGS. 12B and 12C. Accordingly, a user of the seal assembly 1200 would know that the primary seal 250 has leaked as a result of the first and second members 1210, 1220 being rotationally fixed relative to one another.

Aspects disclosed herein include:

A. A seal assembly, the seal assembly including: 1) a first member, the first member formed of a first material; 2) a second member overlapping with the first member, the second member formed of a second material, the first and second members defining an overlapping fluid leakage path; 3) a primary seal positioned in the overlapping fluid leakage path, the primary seal configured to prevent fluid from passing from a first side of the overlapping fluid leakage path to a second side of the overlapping fluid leakage path; and 4) an expandable metal backup seal positioned in the second side of the overlapping fluid leakage path, the expandable metal backup seal including a metal configured to expand in response to hydrolysis.

B. A seal assembly, the seal assembly including: 1) a first member, the first member formed of a first material; 2) a second member overlapping with the first member, the second member formed of a second material, the first and second members defining an overlapping fluid leakage path; 3) a primary seal positioned in the overlapping fluid leakage path, the primary seal configured to prevent fluid from passing from a first side of the overlapping fluid leakage path to a second side of the overlapping fluid leakage path; and 4) an expanded metal backup seal positioned in the second side of the overlapping fluid leakage path, the expanded metal backup seal comprising a metal that has expanded in response to hydrolysis.

C. A well system, the well system including: 1) a wellbore located in a subterranean formation; and 2) a seal assembly positioned within the wellbore, the seal assembly including: a) a first member, the first member formed of a first material; b) a second member overlapping with the first member, the second member formed of a second material, the first and second members defining an overlapping fluid leakage path; c) a primary seal positioned in the overlapping fluid leakage path, the primary seal configured to prevent fluid from passing from a first side of the overlapping fluid leakage path to a second side of the overlapping fluid leakage path; and d) an expandable metal backup seal positioned in the second side of the overlapping fluid leakage path, the expandable metal backup seal including a metal configured to expand in response to hydrolysis.

Aspects A, B, and C may have one or more of the following additional elements in combination: Element 1: wherein the first member is a first tubular member and the second member is a second tubular member positioned within the first tubular member. Element 2: further including a first groove located in one of the first tubular member or the second tubular member, the primary seal positioned within the first groove. Element 3: wherein the primary seal is a ring shaped primary seal. Element 4: wherein the ring shaped primary seal is an O-ring seal, X-ring seal, or a T-ring seal. Element 5: wherein the ring shaped seal is a chevron seal. Element 6: wherein the primary seal is a polymeric or elastomeric seal. Element 7: wherein the primary seal is a metal seal. Element 8: further including a second groove located in one of the first tubular member or the second tubular member, the expandable metal backup seal positioned within the second groove. Element 9: wherein the expandable metal backup seal includes one or more solid rings of expandable metal. Element 10: wherein the expandable metal backup seal includes two or more wraps of expandable metal. Element 11: wherein the first member and the second member are fixed relative to one another. Element 12: wherein the first member and the second member move relative to one another. Element 13: wherein the first member and the second member translate relative to one another. Element 14: wherein the first member and the second member rotate relative to one another. Element 15: wherein a cross-sectional area of the expandable metal backup seal is no more than 30 cm². Element 16: wherein the cross-sectional area of the expandable metal backup seal ranges from 3 cm² to 20 cm². Element 17: wherein the expandable metal backup seal is in an unexpanded state that does not provide a fluid tight seal to the overlapping fluid leakage path. Element 18: wherein the expandable metal backup seal is in an expanded state that does provide a fluid tight seal to the overlapping fluid leakage path. Element 19: wherein the expandable metal backup seal includes an expanded metal cement like material and residual unreacted metal configured to expand in response to the hydrolysis. Element 20: wherein a cross-sectional area of the expanded metal backup seal is no more than 60 cm². Element 21: wherein the cross-sectional area of the expanded metal backup seal ranges from 7 cm² to 52 cm². Element 22: wherein the expanded metal backup seal includes an expanded metal cement like material and residual unreacted metal configured to expand in response to the hydrolysis. Element 23: wherein the seal assembly forms at least a portion of a completion string located within the wellbore. Element 24: wherein the seal assembly forms at least a portion of a drill string, a stimulation string, a workover string located within the wellbore. Element 25: wherein a cross-sectional area of the expandable metal backup seal is no more than 30 cm². Element 26: wherein the cross-sectional area of the expandable metal backup seal ranges from 3 cm² to 20 cm². Element 27: wherein the expandable metal backup seal includes an expanded metal cement like material and residual unreacted metal configured to expand in response to the hydrolysis.

Those skilled in the art to which this application relates will appreciate that other and further additions, deletions, substitutions and modifications may be made to the described embodiments.

What is claimed is:

1. A seal assembly, comprising:
a first member, the first member formed of a first material;
a second member overlapping with the first member, the second member formed of a second material, the first and second members defining an overlapping fluid leakage path;
a primary seal positioned in the overlapping fluid leakage path, the primary seal configured to prevent fluid from passing from a first side of the overlapping fluid leakage path to a second side of the overlapping fluid leakage path; and
a backup seal structure positioned in the overlapping fluid leakage path downstream of the fluid from the primary seal, the backup seal structure including an expandable metal body configured to expand in response to hydrolysis, wherein the expandable metal body:
is configured to be isolated from the fluid until such time as the primary seal unintentionally breaches; and
only after the primary seal unintentional breaches is the fluid allowed to contact the expandable metal body to form a permanent backup seal.

2. The seal assembly as recited in claim 1, wherein the first member is a first tubular member and the second member is a second tubular member positioned within the first tubular member.

3. The seal assembly as recited in claim 2, further including a first groove located in one of the first tubular member or the second tubular member, the primary seal positioned within the first groove.

4. The seal assembly as recited in claim 3, wherein the primary seal is a ring shaped primary seal.

5. The seal assembly as recited in claim 4, wherein the ring shaped primary seal is an O-ring seal, X-ring seal, or a T-ring seal.

6. The seal assembly as recited in claim 4, wherein the ring shaped seal is a chevron seal.

7. The seal assembly as recited in claim 4, wherein the primary seal is a polymeric or elastomeric seal.

8. The seal assembly as recited in claim 4, wherein the primary seal is a metal seal.

9. The seal assembly as recited in claim 3, further including a second groove located in one of the first tubular member or the second tubular member, the expandable metal backup seal positioned within the second groove.

10. The seal assembly as recited in claim 9, wherein the expandable metal backup seal includes one or more solid rings of expandable metal.

11. The seal assembly as recited in claim 9, wherein the expandable metal backup seal includes two or more wraps of expandable metal.

12. The seal assembly as recited in claim 1, wherein the first member and the second member are fixed relative to one another.

13. The seal assembly as recited in claim 1, wherein the first member and the second member move relative to one another.

14. The seal assembly as recited in claim 13, wherein the first member and the second member translate relative to one another.

15. The seal assembly as recited in claim 13, wherein the first member and the second member rotate relative to one another.

16. The seal assembly as recited in claim 1, wherein a cross-sectional area of the expandable metal backup seal is no more than 30 cm².

17. The seal assembly as recited in claim 16, wherein the cross-sectional area of the expandable metal backup seal ranges from 3 cm² to 20 cm².

18. The seal assembly as recited in claim 1, wherein the expandable metal backup seal is in an unexpanded state that does not provide a fluid tight seal to the overlapping fluid leakage path.

19. The seal assembly as recited in claim 1, wherein the expandable metal backup seal is in an expanded state that does provide a fluid tight seal to the overlapping fluid leakage path.

20. The seal assembly as recited in claim 19, wherein the expandable metal backup seal includes an expanded metal cement like material and residual unreacted metal configured to expand in response to the hydrolysis.

21. A seal assembly, comprising:
a first member, the first member formed of a first material;
a second member overlapping with the first member, the second member formed of a second material, the first and second members defining an overlapping fluid leakage path;
an unintentionally breached primary seal positioned in the overlapping fluid leakage path, the primary seal originally configured to prevent fluid from passing from a first side of the overlapping fluid leakage path to a second side of the overlapping fluid leakage path but over time failed; and
a backup seal structure positioned in the overlapping fluid leakage path downstream of the fluid from the unintentionally breached primary seal, the backup seal structure including an expanded metal backup seal comprising a cement like material that resulted from a metal that has expanded in response to hydrolysis.

22. The seal assembly as recited in claim 21, wherein a cross-sectional area of the expanded metal backup seal is no more than 60 cm².

23. The seal assembly as recited in claim 22, wherein the cross-sectional area of the expanded metal backup seal ranges from 7 cm² to 52 cm².

24. The seal assembly as recited in claim 21, wherein the expanded metal backup seal includes an expanded metal cement like material and residual unreacted metal configured to expand in response to the hydrolysis.

25. A well system, comprising:
a wellbore located in a subterranean formation; and
a seal assembly positioned within the wellbore, the seal assembly including:
a first member, the first member formed of a first material;
a second member overlapping with the first member, the second member formed of a second material, the first and second members defining an overlapping fluid leakage path;
a primary seal positioned in the overlapping fluid leakage path, the primary seal configured to prevent fluid from passing from a first side of the overlapping fluid leakage path to a second side of the overlapping fluid leakage path; and
a backup seal structure positioned in the overlapping fluid leakage path downstream of the fluid from the primary seal, the backup seal structure including an expandable metal body configured to expand in response to hydrolysis, wherein the expandable metal body:
is configured to be isolated from the fluid until such time as the primary seal unintentionally breaches; and
only after the primary seal unintentional breaches is the fluid allowed to contact the expandable metal body to form a permanent backup seal.

26. The well system as recited in claim 25, wherein the seal assembly forms at least a portion of a completion string located within the wellbore.

27. The well system as recited in claim 25, wherein the seal assembly forms at least a portion of a drill string, a stimulation string, a workover string located within the wellbore.

28. The well system as recited in claim 25, wherein a cross-sectional area of the expandable metal backup seal is no more than 30 cm².

29. The well system as recited in claim 28, wherein the cross-sectional area of the expandable metal backup seal ranges from 3 cm² to 20 cm².

30. The well system as recited in claim 25, wherein the expandable metal backup seal includes an expanded metal cement like material and residual unreacted metal configured to expand in response to the hydrolysis.
